(19) United States
(12) Patent Application Publication
(10) Pub. No.: US 2018/0241303 A1
(43) Pub. Date: Aug. 23, 2018

(54) POWER SUPPLIES WITH PRE-POWERED ACTIVE INRUSH CURRENT CONTROL CIRCUITS

(71) Applicant: HEWLETT PACKARD ENTERPRISE DEVELOPMENT LP, Houston, TX (US)

(72) Inventors: Mark Isagani Bello Rivera, Houston, TX (US); Stephen Airey, Houston, TX (US); David P. Mohr, Houston, TX (US); Daniel Humphrey, Houston, TX (US)

(21) Appl. No.: 15/439,193

(22) Filed: Feb. 22, 2017

(51) Int. Cl. H02M 1/32; H02M 1/42; H02M 7/06

(52) U.S. Cl. CPC H02M 1/32; H02M 7/06; H02M 1/42

(57) ABSTRACT

Examples relate to power supply comprising a power source to generate an inrush current, an active inrush current control circuit that is electrically coupled between the power source and a bulk capacitor and that is to control inrush current to the bulk capacitor, and an energy storage component electrically coupled to the active inrush current control circuit that is to power the active inrush current control circuit prior to operation of the power supply.

### BACKGROUND

Power supply circuits connected to a line voltage supply may be subjected to short-duration, high amplitude, input current (known as inrush current). The inrush current may be the steady state current until the power supply reaches equilibrium, e.g., the transient effect continues until the voltage across the internal power supply capacitance reaches a voltage approximately equal to the peak amplitude of the line voltage supply. If uncontrolled, the inrush current may result in internal power supply capacitance absorbing energy beyond its rated value as well as subjecting power supply components to damaging current levels that may potentially result in failures of said power supply components, such as blowing fuses, wires, etc., or other external components such as breakers in a Power Distribution Unit (PDU).

### BRIEF DESCRIPTION OF THE DRAWINGS

The following detailed description references the drawings, wherein:

FIG. 1 is a block diagram of an example power supply with a pre-powered active inrush current control circuit, wherein the active inrush current control circuit is pre-powered by storage energy components.

FIG. 2 is a block diagram of another example power supply with a pre-powered active inrush current control circuit, wherein the active inrush current control circuit is pre-powered by storage energy components, including a bias converter.

FIG. 3 is a block diagram of another example power supply with a power factor correction control circuit to which the active inrush current control circuit is connected, including energy storage components to pre-power the active inrush current control circuit.

FIG. 4 is a flowchart of an example method for pre-powering an active inrush current control circuit in power supplies by energy storage components electrically coupled to the active inrush current control circuit.

FIG. 5 is a block diagram of an example computing device with a processing resource to execute instructions in a machine-readable storage medium for pre-powering an active inrush current control circuit in power supplies by energy storage components electrically coupled to the active inrush current control circuit.

### DETAILED DESCRIPTION

Inrush current control circuits may be incorporated in power supply designs, for example server power supply designs, for managing charging of bulk capacitors during initial power-up. A bulk capacitor in a power supply, that may be a combination of capacitors connected in series or in parallel, may be used to prevent the output of power supply from dropping too far during the periods when the utility is not available. The use of inrush current control circuits may reduce the cost and current capacity sizing for elements in power supplies designed for preventing damage due to inrush current, such as input power line connectors, wiring, breakers and other input power line distribution hardware. Limiting load transients generated by inrush current further reduces cost by preventing the use of larger upstream input power sources.

However, active inrush current control circuits in power supplies are initially un-energized and therefore, intelligent control of the active inrush current control sequence (sequence of openings and closings of switches managed by the inrush current control circuit) applied to the power supply, by means of a controller (with all their support circuitry), cannot be performed until input power from a power source of the power supply comes into the active inrush current control circuit (the controller is not powered until the bulk capacitor in the power supply is charged by the power source of the power supply until a pre-determined level). Besides, the active switches of the active inrush current control circuits that apply the active inrush current control sequence, e.g., transistors such as Field-Effect Transistors (FETs), Insulated Gate Bipolar Transistors (IGBTs), etc., may have no gate drive signals (drive gate signal are provided by the controller of the inrush current control circuit) so they cannot be turned on or off as needed. Moreover, monitoring input current through a sense resistor that may be connected to an operational amplifier in the active inrush current control circuit cannot be performed since the operational amplifier is also initially un-powered.

To address these issues, examples disclosed herein describe an example power supply for controlling inrush current to a bulk capacitor of the power supply. The power supply comprises a power source to generate the inrush current, an active inrush current control circuit that is electrically coupled between the power source and the bulk capacitor and an energy storage component electrically coupled to the active inrush current control circuit that is to power the active inrush current control circuit prior to operation of the power source. By having pre-charged energy storage components powering the active inrush current control circuit prior to operation of the power source, intelligent control over inrush current is available before input power is applied to the power source. Besides, by having pre-charged energy storage components energizing the active inrush current control circuit after removal of the power source, the solution may also provide intelligent control for inrush currents when input power source recovers.

In some examples, the active inrush current control circuit comprises a controller, e.g., a microcontroller or a control Integrated Circuit (IC), to generate the active inrush current control sequence applied to at least one switch of the power supply. The at least one switch open and closed based on the received active inrush current control sequence, allowing or avoiding the circulation of current from the power source to the bulk capacitor. Said controller further allows to actively measure the amount of inrush current coming from the power source and the amount of inrush current that is allowed to pass to the rest of components of the power supply, for example, to the bulk capacitor.

In some examples, the energy storage components may be pre-charged by the power source through a converter selected form a group comprising a bias converter, an output converter or an independent converter (not part of another converter). In some other examples, after initial power-up of the power supply and once the power supply reaches equilibrium (e.g. converters in power supply have started up and are operating correctly), the energy storage components may be re-charged by the power source through a converter selected from a group comprising a bias converter, an output converter or an independent converter (not part of another converter), these converters being from the primary side of the power supply.

In some examples, the power supply further comprises a Power Factor Correction (PFC) control circuit to correct a nonlinearity of the power supply. In such examples, the switches receiving the active inrush current control sequence from the active current control circuit may be part of the PFC control circuit. In some other examples, the switches receiving the active inrush current control sequence from the active current control circuit may be part of other elements of the power supply, such as a rectifier. In some other examples, the switches may be selected from a group comprising electromechanical devices, electrical devices, switching voltage regulators, transistors, relays, logic gates, binary state logics, or other type of electrical devices that may interrupt the current flow to the bulk capacitor.

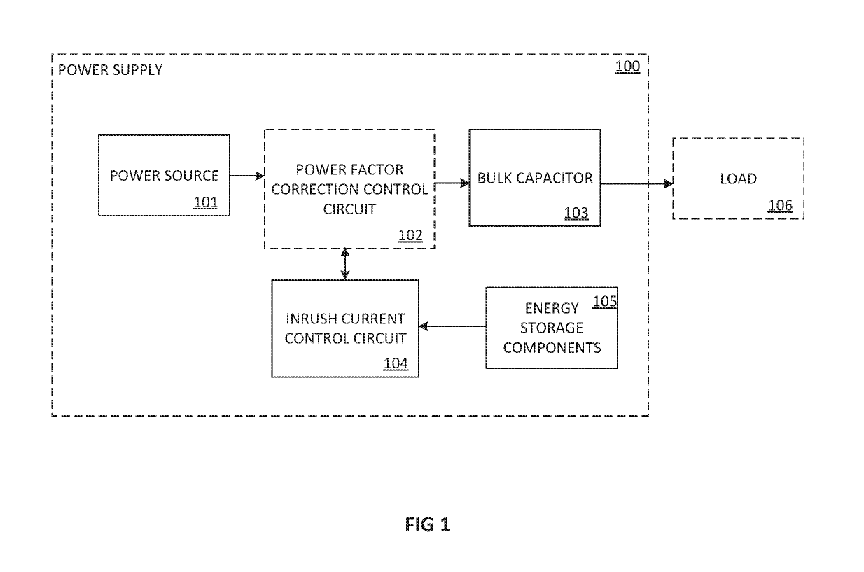

Referring now to the drawings, FIG. 1 is a block diagram of an example power supply 100 with a pre-powered active inrush current control circuit 104, wherein the active inrush current control circuit 104 is pre-powered by storage energy components 105 electrically coupled to the active inrush current control circuit 104. It should be understood that the power supply 100 depicted in FIG. 1 may include additional components and that some of the components described herein may be removed and/or modified without departing from a scope of the power supply 100.

The power supply 100 comprises a power source 101 connected to a PFC control circuit 102 that is, in turn, connected to a bulk capacitor 103. The output of the bulk capacitor 103 is also connected to a load 106. As used herein a “load” may comprise a power/energy consuming device, such as a server, computing device, etc. In some examples, the load 106 may receive power from the bulk capacitor 103 by interposition of an output converter that is electrically coupled to the bulk capacitor 103 and to the load 106. The power supply 100 also comprises an active inrush current control circuit 104 connected to the PFC control circuit 102 and energy storage components 105, such as capacitors, batteries, supercapacitors, hybrid-capacitor-battery components, combinations thereof, etc., that are to power the active inrush current control circuit 104 prior to operation of the power source 101. In such example, the energy storage components 105 may be pre-charged and recharged by means of a connection with the power source 101.

The active inrush current control circuit 104 may comprise a controller, e.g., a microcontroller or a control Integrated Circuit (IC), which monitors the bulk capacitor voltage and the inrush current generated by the power source 101. The controller generates and outputs an active inrush current control sequence applied to at least one switch of the power supply 100. The at least one switch open and closed based on the received active inrush current control sequence, allowing or avoiding the circulation of current from the power source 101 to the bulk capacitor 103. The controller may stop once the bulk capacitor is charged up to a pre-determined level.

As used herein, the “power source” 101 may be an energy source that provides the energy to the load 106. The power source 101 is also to generate the inrush current when the power supply 100 is initially powered-up. Thus, the power source 101 provides energy to the bulk capacitor 103 which in turn provides energy in conjunction with the power factor correction converter to the load 106, and as such, examples of the power source 101 includes Alternating Current (AC) power sources, Direct Current (DC) power sources, power feeds, generators, power circuits, energy storages, power systems, or other type of voltage source capable of providing the input voltage and current to the rest of components of the power supply 100 and to the load 106. In some examples, the power source 101 may be the energy source that powers and pre-charges the energy storage components 105 prior to operation of the power supply 100 and that, after initial power-up of the power supply 100 and once the power supply 100 reaches equilibrium, also re-charges the energy storage components 105.

As used herein, the “PFC control circuits” 102 may be control circuits in power transmission systems that may reduce transmission losses and improve voltage regulation at the load 106. PFC control circuits 102 may rectify alternating current received from an alternating power source and provide power factor correction. PFC control circuits 102 may shape current and maintain an output voltage. In some examples, the PFC control circuit 102 may comprise a boost converter, a buck-boost PFC converter, a buck PFC converter or other PFC converters.

As used herein, “bulk capacitor” 103 may be a combination of capacitors, connected in series or in parallel, which are to filter direct current flow, to prevent the output of the power supply 100 from dropping too far during the periods when current is not available and to instantly supply energy stored in the bulk capacitor 103 to the load 106.

As used herein, “energy storage components” 105 may be elements able to capture energy produced at one time, to store the captured energy for a period and to use the stored energy at a later time. Examples of energy storage components 105 may be capacitors, batteries, supercapacitors, hybrid-capacitor-battery components, combinations thereof, etc.

Managing the inrush of current into the bulk capacitor 103 by powering the active inrush current control circuit 104 prior to operation of the power supply 100 and after power supply 100 is turned off, enables power supply 100 to provide protection to hardware components that may experience failure and/or breakdown at a particular current level and to provide an intelligent control over the active inrush current control sequence managed by the inrush current control circuit 104. For example, the active inrush current control circuit 104 may manage the inrush of current to the bulk capacitor 103 by keeping the current level under a particular threshold. This example may manage the inrush of current without blowing fuses, breakers, and other hardware component associated with the power supply 100.

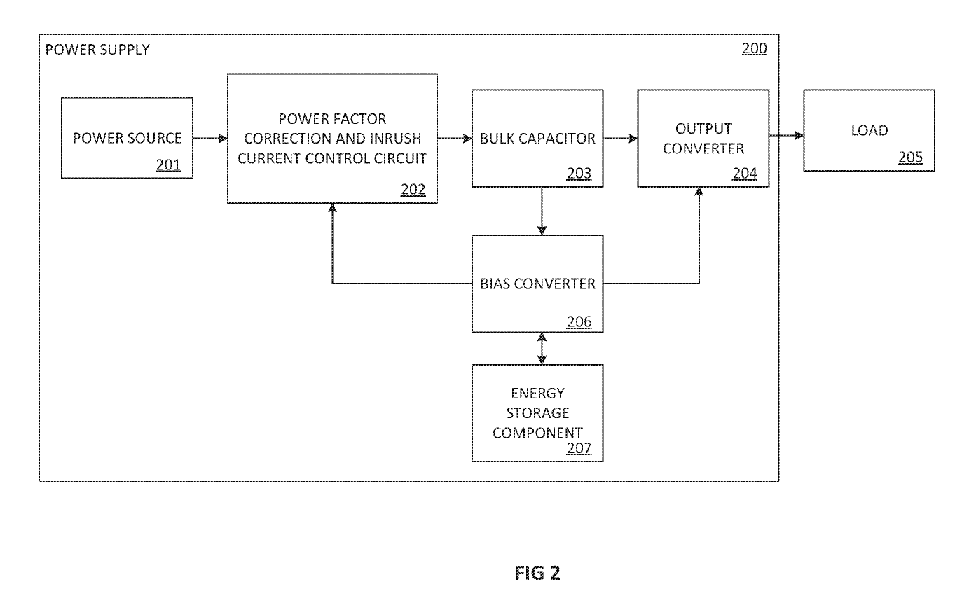

FIG. 2 is a block diagram of another example power supply 200 with a pre-powered active inrush current control circuit 202, wherein the active inrush current control circuit 202 is pre-powered by storage energy components 207, and including a bias converter 206. It should be understood that the power supply 200 depicted in FIG. 2 may include additional components and that some of the components described herein may be removed and/or modified without departing from a scope of the power supply 200.

The power supply 200 comprises a power source 201 connected to a PFC and inrush current control circuit 202 that is, in turn, connected to a bulk capacitor 203. The output of the bulk capacitor 203 is connected to a load 205 by interposition of an output converter 204. In the example of FIG. 2, the PFC control circuit and the inrush current control circuit are shown as an element called power factor correction and inrush current control circuit 202. However, the PFC control circuit and the inrush current control circuit may be two independent elements electrically coupled as shown in FIG. 1. Besides, in the example of FIG. 2 the output converter 204 is shown as being part of the power supply 200, but in some other examples the output converter 204 may be part of the load 205.

The power supply 200 comprises an energy storage component 207, such as batteries, capacitors, supercapacitors, hybrid-capacitor-battery components, combinations thereof, etc., that is pre-charged and recharged by means of a connection with the power source 201. The pre-charged energy storage component 207 are to power the PFC and inrush current control circuit 202 prior to operation of the power source 101, such that intelligent control over inrush current is available before input power comes in by way of the active inrush current control circuit. The pre-charged energy storage component 207 are also to power the inrush current control circuit after input power from power source is removed such that intelligent control for inrush currents in power supplies is also provided even when no input power from the power source is received.

The power supply 200 further comprises a bias converter 206 that is electrically coupled between the PFC and inrush current control circuit 202 and the output converter 204 and is for generating a bias signal according to a control voltage with energy from the bulk capacitor 203. The bias converter 206 may include a transistor and a current-to-voltage circuit. The bias converter 203 is to provide overhead power to the power supply 200, e.g., to take energy from the bulk capacitor 203 and convert the energy for feeding control circuitry of the power supply including both primary side components and secondary side components. As shown in FIG. 2, the bias signal may be for feeding the PFC and inrush current control circuit 202 and the output converter 204.

In some other examples, the energy storage component 207 may be pre-powered and recharged by an energy source selected from a group comprising the power source 201 through a power supply output rail (V_{OUT}), an energy source of the primary side of the power supply through a primary side rail (Primary V_{CC}), an energy sources from the secondary side of the power supply through a secondary side rail (Secondary V_{CC}), a full voltage boosted bulk capacitor or any combination thereof. The energy source may be the power source 201 if the energy source is on the primary side of the power supply 200 or may be the power source of a parallel power supply if the energy source is on the secondary side of the power supply 200. In some other examples, the energy storage component 207 may be pre-powered and recharged by an energy source by interposition of a charger to a pre-determined level.

In some examples, the output converter 204 may provide electrical isolation and produce a desired output voltage (tightening the output voltage range) to satisfy the voltage range of the load 205. In some other examples, power supply 200 may omit the output converter 204.

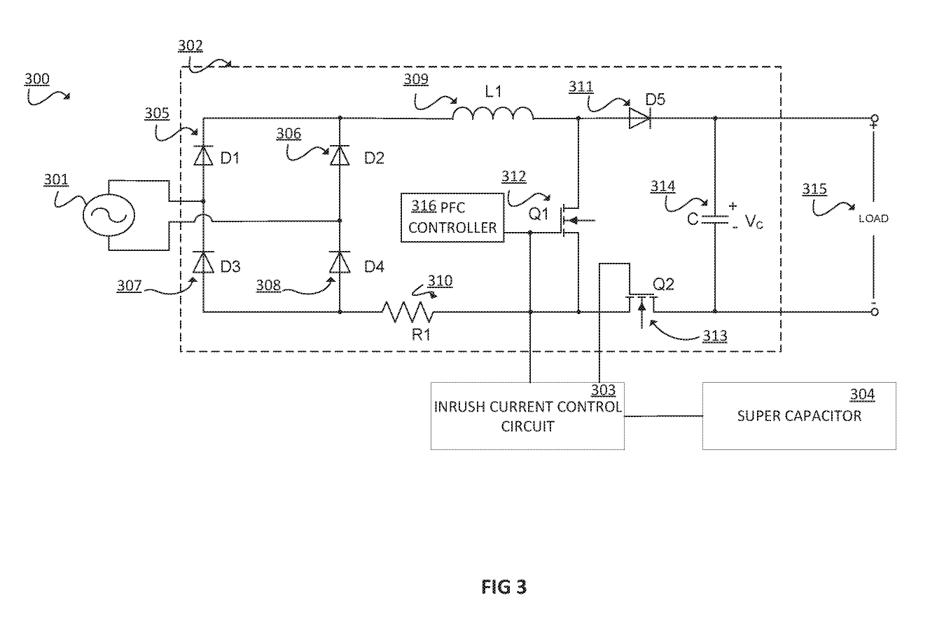

FIG. 3 is a block diagram of another example power supply 300 with a PFC control circuit 302 to which the active inrush current control circuit 303 is connected, including the energy storage components 304 to pre-power the active inrush current control circuit 303. It should be understood that the power supply 300 depicted in FIG. 3 may include additional components and that some of the components described herein may be removed and/or modified without departing from a scope of the power supply 300.

The power supply 300 comprises an alternating current (AC) power source 301 coupled to a PFC boost converter 302. The PFC boost converter 302 comprises a full-wave bridge rectifier formed by four diodes D1-D4 305-308, inductor L1 309, boost diode D5 311, resistor R1 310, bulk capacitor C, a first N-channel Field Effect Transistor (FET) switch Q1 312 and a second N-channel FET switch Q2 313. The PFC boost converter 302 is to change the wave form of the input current to improve a power factor. Resistor R1 310 is a sense resistor to monitor input current in the PFC control circuit 302. Second N-channel FET switch Q2 313 is to actively control inrush current charging the bulk capacitor C 314 at initial application of input power. The PFC boost converter 302 further comprises a PFC controller 316 that is to take input from resistor R1, power source 301 and bulk capacitor C 314, V_{C}, and correct power factor and regulate the bulk capacitor voltage.

In such example the power supply 300 comprises a PFC boost converter 302 but in other implementations, power supply 300 may comprise other PFCs such as a buck-boost PFC converter and a buck PFC converter.

Other examples of switches Q1 312 and Q2 313 may include electromechanical devices, electrical devices, switching voltage regulators, transistors, relays, logic gates, binary state logics, or other type of electrical device that may interrupt the flow to the bulk capacitor 314. The bulk capacitor 314 may be a hardware component used to store energy electrostatically in an electrical field.

The power supply 300 further comprises the active inrush current control circuit 303 electrically coupled to the first N-channel Field Effect Transistor (FET) switch Q1 312 and to a second N-channel FET switch Q2 313, such that the active inrush current control circuit 303 provides the switches 312 and 313 with an active inrush current control sequence. The switches 312 and 313 are to open and close, allowing or avoiding current to pass towards the bulk capacitor 314, based on the active inrush current control sequence received from the active inrush current control circuit 303. The active inrush current control circuit 303 is connected to a supercapacitor 304 to power the active inrush current control circuit 303 prior to operation of the AC power source 301. The supercapacitor 304 is, in turn, connected to the AC power source 301 to be pre-charged and recharged once the AC power source 301 is powered-up and has reached equilibrium.

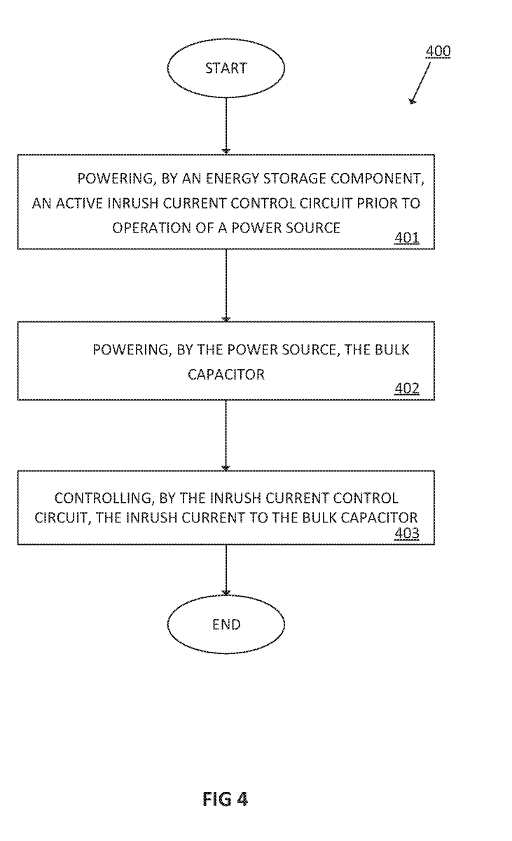

FIG. 4 is a flowchart of an example method 400 for pre-powering an active inrush control circuit in power supplies by energy storage components electrically coupled to the active inrush current control circuit. Although execution of method 400 is described below with reference to the power supply 100 of FIG. 1, other suitable power supplies or systems for the execution of method 400 may be utilized, such as power supplies of FIGS. 2 and 3. Additionally, implementation of method 400 is not limited to such examples.

At block 401 of method 400, the energy storage component 105, which is electrically coupled to the active inrush current control circuit 104 in the power supply 100, powers the active inrush current control circuit 104 prior to operation of the power source 101.

At block 402 of method 400, the power source 101 powers the bulk capacitor 103 generating the inrush current in the power supply 100.

At block 403 of method 400, the active inrush current control circuit 104 controls the inrush current to the bulk capacitor 103 by providing an active inrush current control sequence to the switches of the power supply 100, for example, switches located in a PFC control circuit 102 of the power supply 100. The switches of the power supply 100 open and dose, allowing or avoiding current from the power source to reach the bulk capacitor 103, based on the active inrush current control sequence received.

In some examples, the energy storage components 105 also power the active inrush current control circuit 104 after power from the power source 101 has ceased, such that the active inrush current control circuit 104 is able to provide the active inrush current control sequence to the switches when the power supply 100 is not working.

By powering the active inrush current control circuit 104, by the pre-charged energy storage components 105, prior to operation, during operation and after operation of the power source 101 in the power supply 100, the bulk capacitor 103 and the rest of components of the power supply 100 are always protected against damage caused by the inrush current, even when the power source 101 is not operating.

Although the flowchart of FIG. 4 shows a specific order of performance of certain functionalities, method 400 is not limited to that order. For example, the functionalities shown in succession in the flowchart may be performed in a different order, may be executed concurrently or with partial concurrence, or a combination thereof. In some examples, functionalities described herein in relation to FIG. 4 may be provided in combination with functionalities described herein in relation to any of FIGS. 1-3 and 5.

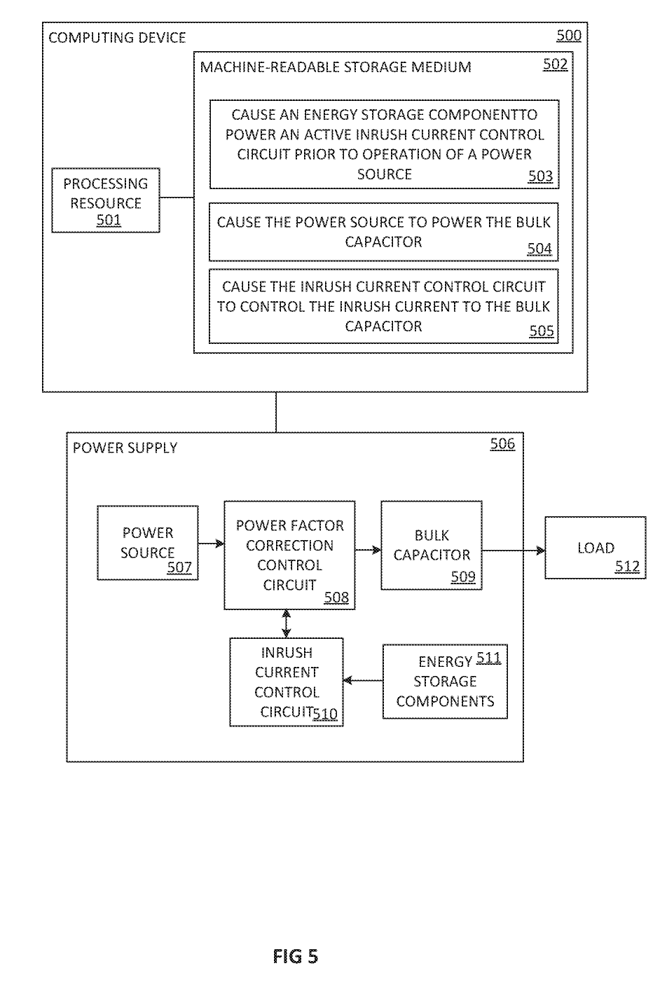

FIG. 5 is a block diagram of an example computing device 500 with a processing resource to execute instructions in a machine-readable storage medium for pre-energizing an active inrush control circuit in power supplies by energy storage components electrically coupled to the active inrush current control circuit. It should be understood that the computing device 500 depicted in FIG. 5 may include additional components and that some of the components described herein may be removed and/or modified without departing from a scope of the computing device 500.

The computing device 500 is depicted as including a processing resource 501 to execute instruction 503-505 in a machine-readable storage medium 502. Specifically, the processing resource 501 of the computing device 500 executes instructions 503 to cause the energy storage components 511 electrically coupled to the active inrush current control circuit 510 in the power supply 506 to power the active inrush current control circuit 510 prior to operation of a power source 507 of the power supply 506.

The processing resource 501 of the computing device 500 also executes instructions 504 to cause the power source 507 to power the bulk capacitor 509 of the power supply 506 through the PFC control circuit 508. The PFC control circuit 508 is to correct nonlinearities of power supply 506. The power source 507 generates at the same time, the inrush current.

The processing resource 501 of the computing device 500 also executes instructions 505 to cause the inrush current control circuit 510 to control the inrush current to the bulk capacitor 509 by applying an active inrush current control sequence to the switches of the PFC control circuit 508.

In some examples, the processing resource 501 may execute instructions to cause the energy storage component 511 to power the active inrush current control circuit 510 after the power from the power source has ceased, by applying an active inrush current control sequence to the switches of the PFC control circuit 508.

As used herein, a “processing resource” 501 may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. Processing resource 501 may fetch, decode, and execute instructions stored on machine-readable storage medium 502 to perform the functionalities described above in relation to instructions 503-505. Processing resource 501 may fetch, decode, and execute instructions stored on machine-readable storage medium 502 to perform the functionalities described above in relation to instructions 503-505. In other examples, the functionalities of the instructions of the machine-readable storage medium 502 may be implemented in the form of electronic circuitry, in the form of executable instructions encoded on a machine-readable storage medium, or a combination thereof. The storage medium may be located either in the computing device executing the machine-readable instructions, or remote from but accessible to the computing device (e.g., via a computer network) for execution.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory. In examples described herein, a machine-readable storage medium or media may be part of an article (or article of manufacture). An article or article of manufacture may refer to any manufactured single component or multiple components.

In some examples, respective instructions 503-505, may be part of an installation package that, when installed, may be executed by the processing resource 501 to implement the functionalities described above. In such examples, machine-readable storage medium 502 may be a portable medium, such as a CD, DVD, or flash drive, or a memory maintained by a server from which the installation package can be downloaded and installed. In other examples, instructions 4503-5052 may be respectively part of an application, applications, or component(s) already installed on devices including processing resource 501. In such examples, the memory-readable storage medium 502 may include memory such as a hard drive, solid state drive, or the like. In some examples, functionalities described herein in relation to FIG. 5 may be provided in combination with functionalities described herein in relation to any of FIGS. 1-4.

Pre-powering inrush current control circuits in power supplies as described herein may be useful for improving control and consistency over power supply designs by avoiding using temperature-dependent resistive elements and low impedance components bypassing the resistive elements as elements of the inrush current control circuit. The solution also provides more control over the active inrush current control sequence applied to switches of the power supply by introducing a controller, microcontroller or control IC in the inrush current control circuit that is powered by the pre-charged energy storage components prior to operation of the power supply and also after power supply is turned off.

All of the features disclosed in this specification (including any accompanying claims, abstract and drawings), and/or all of the elements of any method or process so disclosed, may be combined in any combination, except combinations where at least some of such features and/or elements are mutually exclusive.

1. A power supply comprising:
a power source to generate an inrush current;
an active inrush current control circuit that is electrically coupled between the power source and a bulk capacitor and that is to control inrush current to the bulk capacitor; and
an energy storage component electrically coupled to the active inrush current control circuit that, when pre-charged, is to power the active inrush current control circuit prior to operation of the power source, wherein the energy storage component is a suercapacitor, a battery, a hybrid-capacitor-battery component, or combinations thereof.

2. The power supply of claim 1, wherein the energy storage component is further to power the active inrush current control circuit after power from the power source has ceased.

3. (canceled)

4. The power supply of claim 1, comprising at least one switch to connect and disconnect the bulk capacitor from the power source.

5. The power supply of claim 4, wherein the active inrush current control circuit comprises a controller to generate an active inrush current control sequence to be applied to the at least one switch.

6. The power supply of claim 5, wherein the controller is a microcontroller or a control integrated circuit.

7. The power supply of claim 1, wherein the active inrush current control circuit is electrically coupled between the power source and the bulk capacitor by interposition of a power factor correction control circuit.

8. The power supply of claim 1, comprising at least one switch that is part of the power factor correction control circuit.

9. The power supply of claim 1, comprising an output converter electrically coupled to the bulk capacitor.

10. The power supply of claim 9, comprising a bias converter that is to receive energy from the bulk capacitor and to convert the energy for control circuitry of power supply.

11. The power supply of claim 1, wherein the active inrush current control circuit is to pre-charge and recharge the energy storage component to a pre-determined level to control inrush current to the bulk capacitor.

12. The power supply of claim 11, wherein the active inrush current control circuit is connected to an element selected from a group comprising the power source, an energy source of a primary side of the power supply, an energy source from a secondary side of the power supply, the bulk capacitor and combinations thereof, and wherein the element is to pre-charge and recharge the energy storage component.

13. The power supply of claim 1, comprising switches, wherein the switches are selected from a group comprising, transistors, electromechanical switching devices, electrical switching devices, switching voltage regulators, relays, logic gates, binary state logics, and combinations thereof.

14. A method comprising:
pre-charging an energy storage component, wherein the energy storage component is a supercapacitor, a battery, a hybrid-capacitor-battery component, or combinations thereof;
powering, by the energy storage component electrically coupled to an active inrush current control circuit in a power supply, the active inrush current control circuit prior to operation of a power source;
powering, by the power source, a bulk capacitor;
controlling, by the inrush current control circuit, the inrush current to the bulk capacitor.

15. The method of claim 14, comprising powering, by the energy storage component, the active inrush current control circuit after power from the power source has ceased.

16. The method of claim 14, comprising powering, by a power source, the energy storage component prior to a subsequent operation of the power source.

17. The method of claim 14, when the power supply has reached equilibrium, comprising recharging, by a power source, the energy storage component.

18. The method of claim 14, actively measuring, by the active current inrush control circuit, a first amount of inrush current coming from the power source and determining a second amount of inrush current that is allowed to pass to the bulk capacitor.

19. A non-transitory machine-readable storage medium comprising instructions that when executed by a processor causes the processor to:
cause a pre-charged energy storage component electrically coupled to an active inrush current control circuit in a power supply to power the active inrush current control circuit prior to operation of a power source of the power supply, wherein the energy storage component is a suercapacitor, a battery, a hybrid-capacitor-battery component, or combinations thereof;
cause the power source to power a bulk capacitor; and
cause the inrush current control circuit to control the inrush current to the bulk capacitor by applying an active inrush current control sequence to at least one switch of the power supply.

20. The non-transitory machine-readable storage medium comprising including the instructions of claim 19, comprising instructions to cause the energy storage component to power the active inrush current control circuit after the power form the power source has ceased.
